(19) United States
(12) Patent Application Publication
(10) Pub. No.: US 2009/0018925 A1
(43) Pub. Date: Jan. 15, 2009

(54) Holiday commerce and holiday expressions in a geo-spatial environment

(75) Inventor: Raj Vasant Abhyanker, Cupertino, CA (US)

Correspondence Address: PILLSBURY WINTHROP SHAW PITTMAN LLP, P.O. BOX 10500, MCLEAN, VA, 22102, US

(73) Assignee: Fatdoor, Inc.

(21) Appl. No.: 11/827,250

(22) Filed: Jul. 10, 2007

(51) Int. Cl. G06Q 30/00

(52) U.S. Cl. 705/26

(57) ABSTRACT

A method and system of holiday commerce and holiday expressions in a geo-spatial environment are disclosed. In one embodiment, a method of organizing a community network includes obtaining member data associated with a member of the community network, determining a location of the member based on the member data, storing the member data in a member repository, obtaining a selection of an occasion from the member, displaying decoration options associated with the occasion to the member, obtaining a purchase selection of decoration options from the member, and displaying a decoration representation associated with the decoration options at the location on the geo-spatial map. The method may further include obtaining a residence representation associated with the member, and displaying the residence representation at the location on the geo-spatial map. The method may also include delivering a decoration associated with the decoration options to the member.

### FIELD OF TECHNOLOGY

This disclosure relates generally to the technical field of communications, and in one embodiment, to a method and system of holiday commerce and holiday expressions in a geo-spatial environment.

### BACKGROUND

Holidays, both national and cultural, are typically associated with observances, activities, symbols, and/or decorations. Observers of a particular holiday may spend a great deal of time preparing for the holiday. For example, observers of the holiday may organize and/or schedule activities for the holiday, prepare food and drink for the holiday, purchase and display decorations related to the holiday, exchange gifts associated with the holiday, visit family and/or friends etc.

Holiday decorations allow observers of a holiday to express themselves as well as the spirit of the holiday. In addition, holiday decorations may be displayed in a variety of public and/or private settings. For example, Christmas decorations may include private presents and cards to others, semi-private trees and ornaments displayed inside a person's home, publicly displayed lights and/or other house decorations. Some holidays, such as Christmas and Halloween, are associated with a variety of public decorations and may prompt recognition and viewing of the decorations in the form of contests, tours, etc.

Holiday decorations may be purchased from retailers. For example, a customer may purchase a Christmas tree from a store or place an order online. Alternatively, holiday decorations may be created and/or assembled from materials obtained from one or more retailers. For example, a Halloween jack-o'-lantern may be created by carving a pumpkin purchased from a store, farm, etc. Because decorations and associated materials for different holidays may be stocked by different retailers, consumers may have difficulty purchasing decorations and associated materials for a given holiday.

In addition, people may have difficulty locating places with prominent decorations associated with a certain holiday. For example, residents of an area may try to locate the best Christmas displays in the area. However, resources such as the Internet may only list Christmas displays in public areas, such as squares or parks, instead of prominent displays located in residential neighborhoods. As a result, residents and/or visitors may be unable to locate elaborate holiday decorations in a neighborhood without physically traveling through the neighborhood themselves.

### SUMMARY OF THE DISCLOSURE

A method and system of holiday commerce and holiday expressions in a geo-spatial environment are disclosed. In one aspect, a method of organizing a community network includes obtaining member data associated with a member of the community network, determining a location of the member based on the member data, storing the member data in a member repository, obtaining a selection of an occasion from the member, displaying a plurality of decoration options associated with the occasion to the member, obtaining a purchase selection of one of the decoration options from the member, and displaying a decoration representation associated with the one of the decoration options at the location on a geo-spatial map.

The method may further include obtaining a residence representation (e.g., based on a residence type) associated with the member, and displaying the residence representation (e.g., may include an image of a residence) at the location on the geo-spatial map. The method may also include delivering a decoration associated with the one of the decoration options to the member. The method may yet include displaying the location on a walking map associated with the occasion.

In another aspect, a community network includes a member repository including a plurality of members, a geo-spatial repository including a plurality of locations on a geo-spatial map, and a member management module configured to obtain member data (e.g., may include one of the locations) associated with each of the members.

The community network further includes a commerce module configured to obtain a selection of an occasion (e.g., may include a national holiday, a cultural holiday, a religious holiday, a secular holiday, an event, and/or a celebration, etc.) from one of the members, display a plurality of decoration options associated with the occasion to the one of the members, obtain a purchase selection of one of the decoration option from the one of the members, and display a decoration representation associated with the one of the decoration options at the one of the locations associated with the one of the members on the geo-spatial map.

In addition, the commerce module may be configured to obtain a residence representation (e.g., based on a residence type) associated with the one of the members, and display the residence representation (e.g., may include an image of a residence) at the one of the locations on the geo-spatial map.

The commerce module may be further configured to deliver a decoration associated with the one of the decoration options to the one of the members. The commerce module may also be configured to display the one of the locations on a walking map associated with the occasion.

In yet another aspect, a method of making a purchase includes selecting a location, selecting an occasion (e.g., a national holiday, a cultural holiday, a religious holiday, a secular holiday, an event, and/or a celebration, etc.), purchasing a decoration associated with the occasion, viewing a decoration representation associated with the decoration at the location on a geo-spatial map, and receiving a delivery of the decoration. The decoration may be delivered using a postal service and/or a delivery service, etc.

The method may further include selecting a residence representation (e.g., may include an image of a residence), and viewing the residence representation at the location on the geo-spatial map. In addition, the method may include receiving a walking map associated with the occasion including the location.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a community network enabling holiday commerce and holiday expressions in a geo-spatial environment, according to one embodiment.

FIG. 2 is a user interface view of selecting an occasion, according to one embodiment

FIG. 3 is a user interface view displaying purchase options associated with Halloween decorations, according to one embodiment.

FIG. 4 is a user interface view displaying decoration representations associated with the occasion along with the residence representation on a geo-spatial map, according to one embodiment.

FIG. 5 is a block diagram representation displaying information associated with a member, according to one embodiment.

FIG. 6 is a flowchart of delivering decorations associated with the occasion based on a purchase, according to one embodiment.

FIG. 7 is a flowchart of receiving delivery of decorations associated with the occasion, according to one embodiment.

FIG. 8 is a diagrammatic system view of a data processing system in which any of the embodiments disclosed herein may be performed, according to one embodiment.

FIG. 9A is a process flow of displaying decoration representations on the geo-spatial map, according to one embodiment.

FIG. 9B is a continuation of the process flow of FIG. 9A, showing additional processes, according to one embodiment.

FIG. 10 is a process flow of making a purchase of decorations associated with the occasion, according to one embodiment.

Other features of the present embodiments will be apparent from the accompanying drawings and from the detailed description that follows.

### DETAILED DESCRIPTION

A method and system of holiday commerce and holiday expressions in a geo-spatial environment are disclosed. In the following description, for the purposes of explanation, numerous specific details are set forth in order to provide a thorough understanding of the various embodiments. It will be evident, however, to one skilled in the art that the various embodiments may be practiced without these specific details.

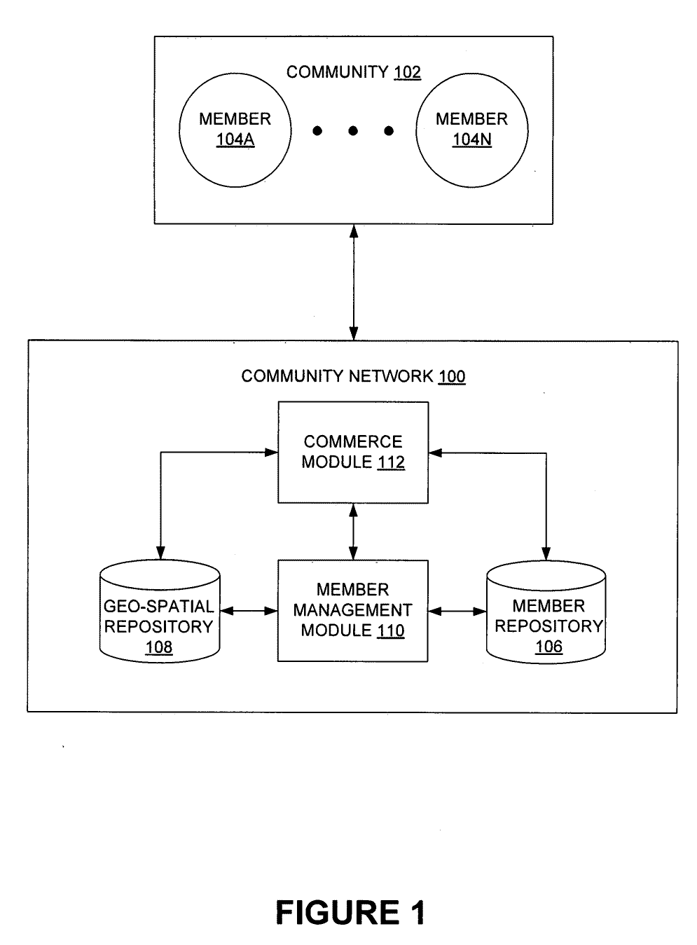

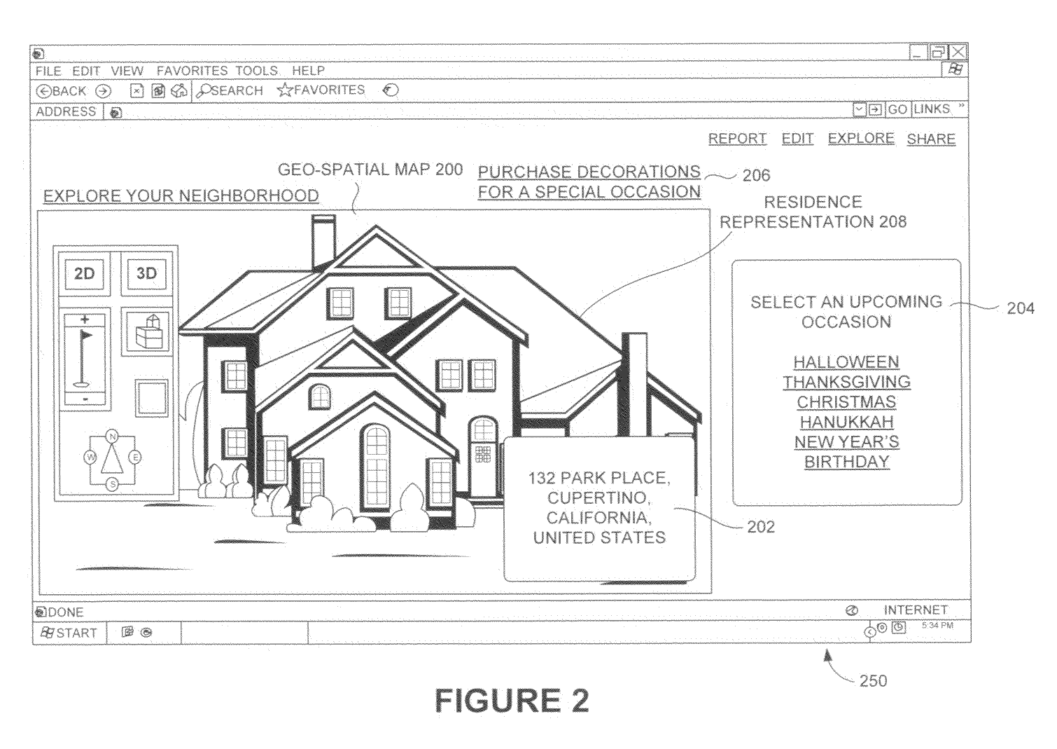

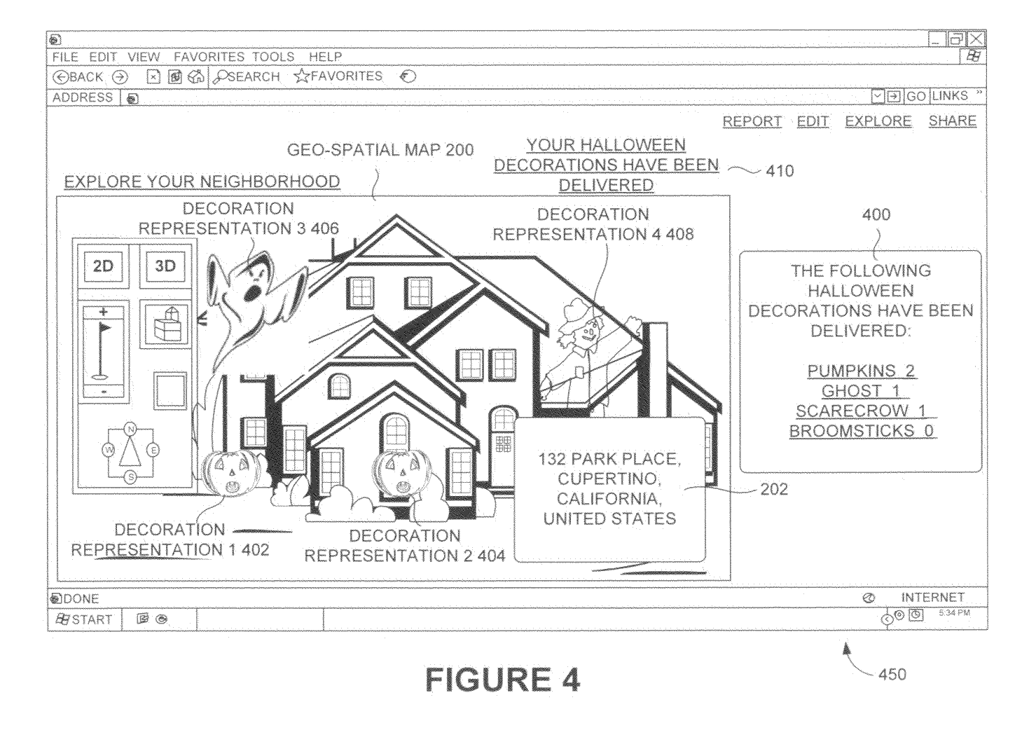

In one embodiment, a method of organizing a community network (e.g., the community network 100 of FIG. 1) includes obtaining member data (e.g., through the member management module 110 of FIG. 1) associated with a member (e.g., the members 104A-N of FIG. 1) of the community network 100, determining a location of the member 104 based on the member data, storing the member data in a member repository (e.g., the member repository 106 of FIG. 1), obtaining a selection (e.g., through the commerce module 112 of FIG. 1) of an occasion from the member 104, displaying decoration options associated with the occasion to the member 104, obtaining a purchase selection of a decoration option (e.g., using the commerce module 112 of FIG. 1) from the member 104, and displaying a decoration representation (e.g., the decoration representations 1 402, 2 404, 3 406, 4 408 of FIG. 4) associated with the decoration options at the location on a geo-spatial map (e.g., the geo-spatial map 200 of FIG. 2).

In another embodiment, a community network (e.g., the community network 100 of FIG. 1) includes a member repository (e.g., the member repository 106 of FIG. 1) including a number of members 104A-N, a geo-spatial repository (e.g., the geo-spatial repository 108 of FIG. 1) including a number of locations on a geo-spatial map (e.g., the geo-spatial map 200 of FIG. 2), a member management module (e.g., the member management module 110 of FIG. 1) configured to obtain member data (e.g., may include a location) associated with each of the members 104A-N. The community network 100 also includes a commerce module (e.g., the commerce module 112 of FIG. 1) configured to obtain a selection of an occasion from a member 104, display decoration options associated with the occasion to the member 104, obtain a purchase selection of a decoration option from the member 104, and display a decoration representation associated with the decoration options at the location associated with the member 104 on the geo-spatial map 200.

In yet another embodiment, a method of making a purchase includes selecting a location, selecting an occasion, purchasing a decoration (e.g., through the commerce module 112 of FIG. 1) associated with the occasion, viewing a decoration representation (e.g., the decoration representations 1 402, 2 404, 3 406 and 4 408 of FIG. 4) associated with the decoration at the location on a geo-spatial map (e.g., the geo-spatial map 200 of FIG. 2), and receiving a delivery of the decoration.

FIG. 1 is a system view of a community network 100 enabling holiday commerce and holiday expressions in a geo-spatial environment, according to one embodiment. Particularly, FIG. 1 illustrates the community network 100, a community 102, members 104A-N, a member repository 106, a geo-spatial repository 108, a member management module 110 and a commerce module 112, according to one embodiment.

The community network 100 may be a network formed by association of the members 104A-N having user profiles in the community 102. The user profiles may include information such as a name, an address, a contact information (e.g., phone number, email address, etc.), a picture, and/or other personal information. The community 102 may be a group of members 104A-N residing in a specific region. For example, the specific region may be a local neighborhood, a suburb, a village, a city, a county, a state, a nation, and/or a group of nations, etc.

The members 104A-N may include persons, businesses and/or organizations associated with specific geographic locations in the community 102. In an alternate embodiment, the members 104A-N may reside in multiple regions (e.g., multiple cities, states, countries, etc.). The members 104A-N may be connected through the community network 100, which may be accessible using network connection.

The member repository 106 may be database containing member data associated with the members 104A-N of the community 102. The geo-spatial repository 108 may be a database containing location information of the members 104A-N. In one example embodiment, locations associated with the members 104A-N may be obtained based on the member data stored in the member repository 106.

The member management module 110 may obtain member data associated with the members 104A-N of the community 102. For example, the member data may include a name, age, profession, location and/or address data associated with the members 104A-N. The member data may be displayed in the user profiles of the members 104A-N. The commerce module 112 may enable the members 104A-N of the community 102 to make a purchase of decorations associated with an occasion. For example, decorations associated with Christmas may include Christmas trees, garlands, Christmas stars, etc. and decorations associated with Halloween may include pumpkin carvings, turnip carvings, ghosts, etc.

In one example embodiment, the commerce module 112 may obtain a selection of the occasion from the members 104A-N. For example, the occasion may include a national holiday, a cultural holiday, a religious holiday, a secular holiday, an event, and/or a celebration, etc. A number of decoration options may be displayed on a geo-spatial map (e.g., the geo-spatial map 200 of FIG. 2) to the members 104A-N corresponding to the selected occasion. For example, decoration options available for Halloween celebrations may include pumpkins, ghosts, scarecrows, and/or broomsticks, etc.

In addition, the commerce module 112 may enable the members 104A-N to select desired decoration options. Further, the commerce module 112 may display decoration representations (e.g., the decoration representations 1 402, 2 404, 3 406 and 4 408 of FIG. 4) associated with the selected decoration options at locations (e.g., associated with the members 104A-N) on the geo-spatial map 200. For example, the decoration representations may include a depiction, an illustration, an icon, etc. associated with the occasion.

Alternatively, the commerce module 112 may obtain a residence representation (e.g., the residence representation 208 of FIG. 2) associated with a member 104 and display the residence representation 208 at a location associated with the member 104. For example, the residence representation 208 may include an image of a residence, business, civic structure, etc. The decoration representations (e.g., pumpkin carvings, Christmas trees, garlands, etc.) may be visualized in conjunction with the residence representation 208 on the geo-spatial map 200. The commerce module 112 may also deliver decorations (e.g., through postal service, courier service, and/or delivery service, etc.) purchased by the members 104A-N at a location.

In accordance with one or more embodiments, member data (e.g., age, gender, profession, address data, etc.) associated with a member 104 of the community network 100 may be obtained (e.g., through the member management module 110 of FIG. 1) and the location of the member 104 may be determined based on the member data. The member data may be stored in the member repository 106. In addition, the residence representation 208 associated with the member 104 may be obtained (e.g., based on a residence type). For example, the residence type associated with the residence representation 208 may include a bungalow, a mansion, an apartment, a flat, a colonial house, and/or a cottage, etc.

The location may be displayed on a walking map associated with the occasion. For example, a walking map may be a geo-spatial map with routes that allow members 104A-N to explore neighborhoods and/or larger areas by navigating. The walking map may also display the decoration representations (e.g., pumpkin carvings, Christmas trees, garlands, etc.) simultaneously with the residence representation 208 associated with the occasion (e.g., Halloween, Christmas, Thanksgiving, etc.).

The member repository 106 may include a number of members 104A-N and the geo-spatial repository 108 may include a number of locations on the geo-spatial map 200. The member management module 110 may be configured to obtain the member data (e.g., may include a number of locations) associated with each of the members 104A-N. The commerce module 112 may be configured to obtain a selection of an occasion (e.g., a national holiday, a cultural holiday, a religious holiday, a secular holiday, an event and/or a celebration, etc.) from a member 104, display decoration options associated with the occasion to the member 104, obtain a purchase selection of the decoration options from the member 104, and display a decoration representation (e.g., the decoration representations 1 402, 2 404, 3 406 and 4 408 of FIG. 4) associated with the decoration options at a location associated with the member 104 on the geo-spatial map 200.

The commerce module 112 may be further configured to obtain a residence representation 208 associated with the member 104 and display the residence representation 208 (e.g., an image of a residence) at the locations on the geo-spatial map 200. For example, the residence representation 208 may be based on a residence type. The commerce module 112 may also be configured to deliver a decoration associated with the decoration options to the member 104. In addition, the commerce module 112 may be configured to display the location on a walking map associated with the occasion.

FIG. 2 is a user interface view 250 of selecting an occasion, according to one embodiment. Particularly, FIG. 2 illustrates a geo-spatial map 200, a profile block 202, a select an upcoming occasion option 204, a purchase decorations for a special occasion link 206 and a residence representation 208, according to one embodiment.

The geo-spatial map 200 may display decoration representations in conjunction with the residence representation 208 at a location associated with the member 104. For example, the location may be obtained based on the member data associated with the members. The profile block 202 may display profile details associated with the residence representation 208 on the geo-spatial map 200. For example, the profile details may include name address data, location data, etc. of residents associated with the residence representation 208. The select an upcoming occasion option 204 may enable the members 104A-N of the community network 100 to select a desired occasion (e.g., a national holiday, a cultural holiday, a religious holiday, a secular holiday, an event, and/or a celebration, etc). For example, the occasion may be selected to purchase decorations associated with the occasion.

The purchase decorations for a special occasion link 206 may enable the members 104A-N to buy decorations for an upcoming occasion (e.g., displayed in the select an upcoming occasion option 204). The residence representation 208 may be a representation of a physical structure associated with a member 104 on the geo-spatial map 200. For example, the residence representation 208 may be an image of the physical structure displayed in conjunction with the decorations purchased by the member 104 of the community network 100.

In the example embodiment illustrated in FIG. 2, the user interface view 250 displays the residence representation 208. The select an upcoming occasion option 204 displays a list of occasions as ‘Halloween’, ‘Thanksgiving’, ‘Christmas’, ‘Hanukkah’, ‘New Year’, ‘birthday’. Residents (e.g., the members 104A-N) associated with the residence representation 208 may select a desired occasion (e.g., a national holiday, a cultural holiday, a religious holiday, a secular holiday, an event, and/or a celebration, etc.) through the select an upcoming occasion option 204. The residents may make a purchase of decorations associated with the selected occasion using the purchase decorations for a special occasion link 206.

For example, a location may be selected. The residence representation 208 (e.g., an image of a residence) may be selected and viewed at the location on the geo-spatial map 200. A selection of an occasion may be obtained (e.g., using the select an upcoming occasion option 204 of FIG. 2) from the member 104. Further, a walking map associated with the occasion containing the location may be received (e.g., by the member 104).

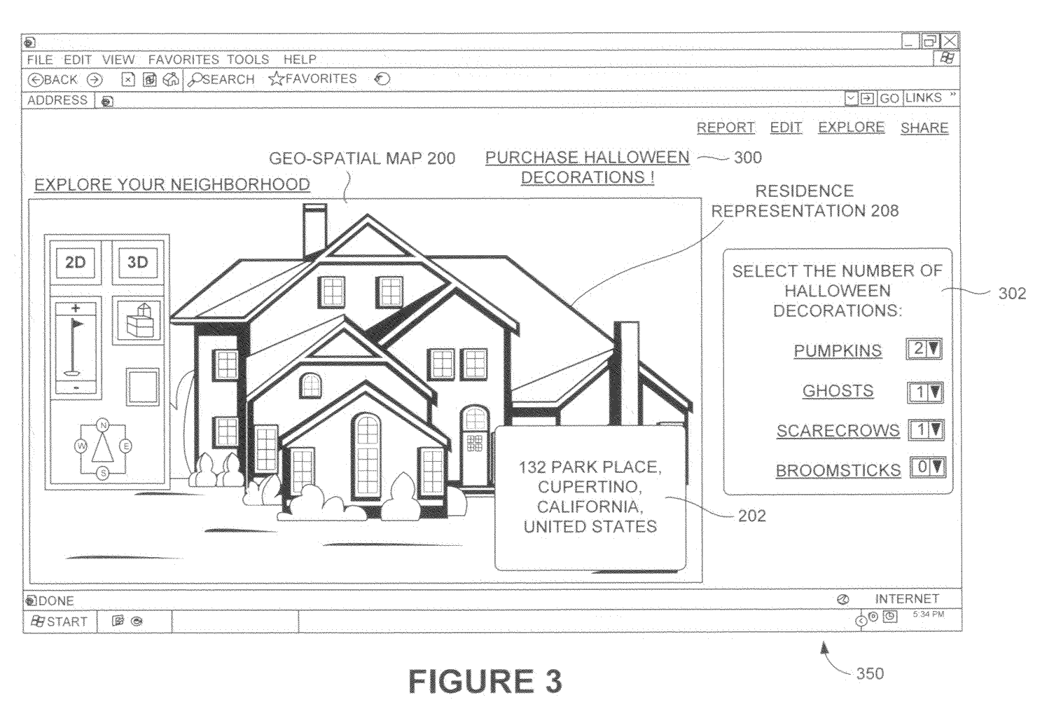

FIG. 3 is a user interface view 350 displaying purchase options associated with Halloween decorations, according to one embodiment. Particularly, FIG. 3 illustrates the geo-spatial map 200, the profile block 202, the residence representation 208, a purchase Halloween decorations link 300 and a select the number of Halloween decorations option 302, according to one embodiment.

The purchase Halloween decorations link 300 may enable the members 104A-N of the community network 100 to purchase Halloween decorations from the decoration options. For example, the Halloween decorations may include pumpkins, ghosts, scarecrow and/or broomsticks, etc. The select the number of Halloween decorations option 302 may enable the members 104A-N to select the number of Halloween decorations that the members 104A-N wish to purchase.

In the example embodiment illustrated in FIG. 3, the user interface view 350 displays purchase options associated with Halloween decoration. The members 104A-N may select desired number of ‘Pumpkins’, ‘Ghosts’, ‘Scarecrows’, and/or ‘Broomsticks’ through the select the number of Halloween decorations option 302. The members 104A-N may also make a purchase of the selected number Halloween decorations through the purchase Halloween decorations link 300.

For example, the decoration options associated with the occasion may also be displayed to the member 104 and a purchase selection of the decoration options may be obtained from the member 104 (e.g., through the purchase Halloween decorations link 300).

FIG. 4 is a user interface view 450 displaying decoration representations associated with an occasion (e.g., Halloween) along with the residence representation 208 on a geo-spatial map 200, according to one embodiment. Particularly, FIG. 4 illustrates the geo-spatial map 200, the profile block 202, the residence representation 208, a block 400, a decoration representation 1 402, a decoration representation 2 404, a decoration representation 3 406, a decoration representation 4 408 and a your Halloween decorations have been delivered link 410, according to one embodiment.

The block 400 may display delivery status of the decorations purchased by a member 104 of the community network 100. For example, the delivery status may include the number of the decorations delivered to the member 104. The decoration representations 1 402, 2 404, 3 406 and 4 408 may be representations of the purchased decorations displayed in conjunction with the residence representation 208 on the geo-spatial map 200. The your Halloween decorations have been delivered link 410 may enable the members 104A-N to view delivery details associated with the purchase of decorations. For example, the delivery details may include a location and/or an address of the member 104, number of decorations, date of delivery, transaction details(e.g., may include financial transactions, physical transactions, etc.) associated with the decorations.

In the example embodiment illustrated in FIG. 4, the user interface view 450 displays the decoration representations 1 402, 2 404, 3 406 and 4 408 (e.g., associated with the decorations delivered to the member 104) along with a residence representation 208. The block 400 displays delivered decorations as ‘Pumpkins-2 numbers’, ‘Ghost-1 number’, ‘Scarecrow-1 number’, and ‘Broomsticks-0 number’ associated with Halloween celebration. For example, the decorations may be delivered through a postal service, a delivery service, and/or a courier service, etc. The decoration representations 1 402, 2 404, 3 406 and 4 408 associated with the decoration options may be displayed at a location on the geo-spatial map 200.

In one example embodiment, a decoration associated with the occasion may be purchased. The decoration representations 1 402, 2 404, 3 406 and 4 408 associated with the decoration may be viewed at a location on the geo-spatial map 200 and a delivery of the decoration may be received by the member 104. In another example embodiment, a decoration associated with the decoration options may be delivered through a postal service, a courier service and/or a delivery service, etc. to the member 104.

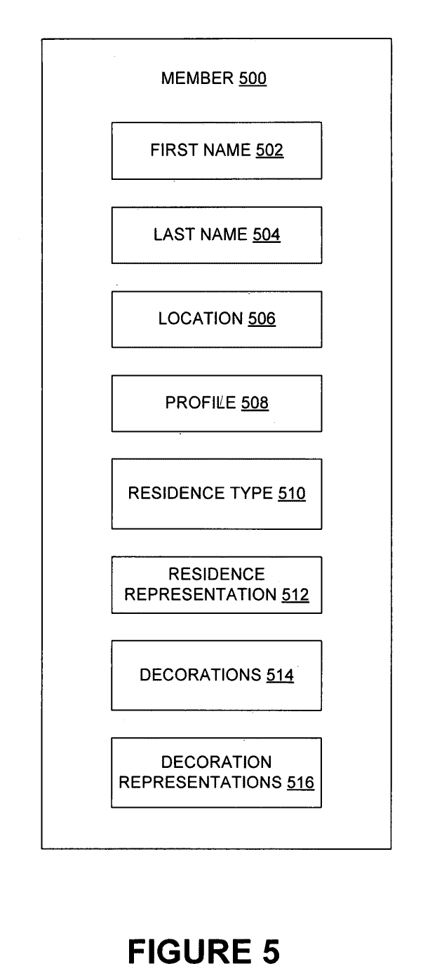

FIG. 5 is a block diagram representation displaying information associated with a member 500, according to one embodiment. In one example embodiment, information is associated with each member 500 of the community network 100. Particularly, FIG. 5 illustrates the member 500, a first name block 502, a last name block 504, a location block 506, a profile block 508, a residence type block 510, a residence representation block 512, a decorations block 514 and a decoration representations block 516, according to one embodiment.

The member 500 may be an individual in the community network 100. The first name block 502 may display first name associated with the member 500. The last name block 504 may display last name associated with the member 500. The location block 506 may display address data associated with the member 500. The location block 506 may also be associated with a latitude, a longitude and an altitude. The profile block 508 may display profile details associated with the member 500. For example, the profile details may include age, gender, profession, hobbies, and/or other personal information.

The residence type block 510 may display type of residence associated with the member 500 of the community network 100. For example, the types of residences associated with the members 104A-N may include a bungalow, a mansion, an apartment, a flat, a colonial house, and/or a cottage, etc. The residence representation block 512 may display various representations of residences associated with the members 104A-N. For example, the residence representation may be an image, a picture, an illustration, a reflection, etc. of a residence displayed on the geo-spatial map 200.

The decorations block 514 may display decorations associated with occasions. For example, decorations associated with Christmas may include Christmas tree, garlands, and/or Christmas star, etc. and decorations associated with Halloween may include pumpkin carvings, turnip carvings, and/or ghosts, etc. The decoration representations block 516 may display various representations of decorations associated with the occasions. For example, the decoration representations may include a depiction, an illustration, and/or an icon, etc.

In the example embodiment illustrated in FIG. 5, the block diagram represents various details (e.g., address data, content data, residence representations, decorations, decoration representations, and/or types of residences, etc.) associated with the member 500. Other members 104A-N may search for the member 500 based on the first name, the last name, the location, the profile, the type of residence, the residence representation, the decoration representations, etc. associated with the member 500.

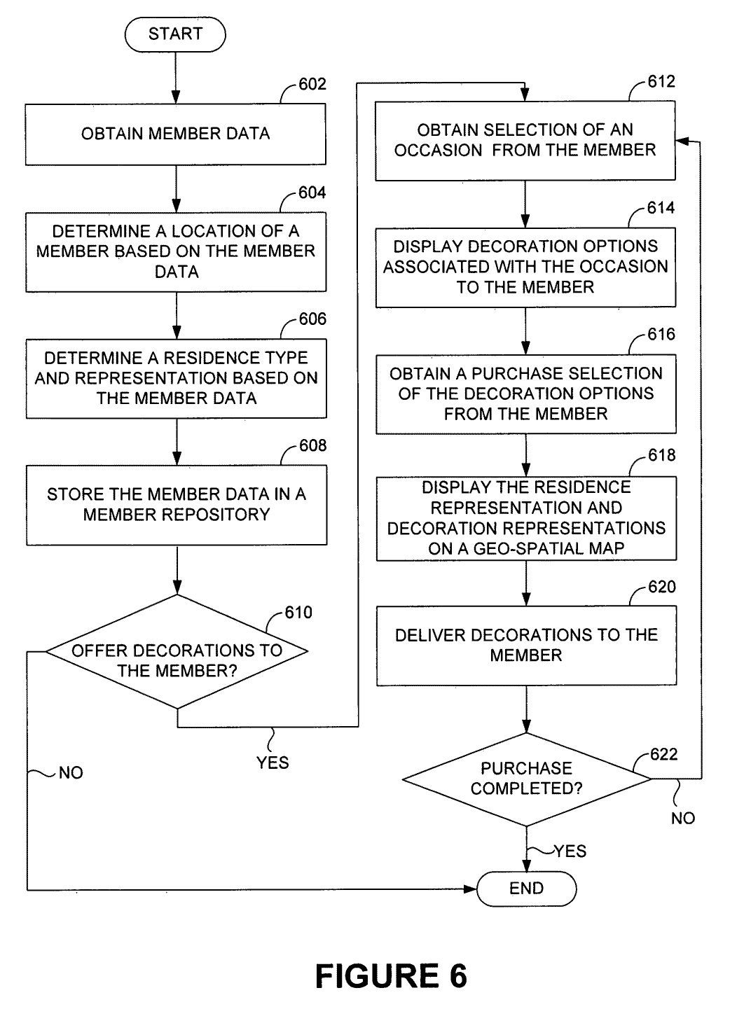

FIG. 6 is a flowchart of delivering decorations associated with an occasion based on a purchase, according to one embodiment. In operation 602, member data associated with a member 104 is obtained (e.g., using the member management module 110 of FIG. 1). For example, the member data may include age, gender, profession, and/or address data, etc. In operation 604, a location of the member 104 is determined based on the member data. For example, the location may be identified on a geo-spatial map 200 using the member data (e.g., may include address data).

In operation 606, a residence type and representation is determined based on the member data. In one example embodiment, the residence type may include a bungalow, a mansion, an apartment, a flat, a colonial house, and/or a cottage, etc. The residence representation may be an image of a residence, business, and/or civic structure etc. In operation 608, the member data is stored in a member repository (e.g., the member repository 106 of FIG. 1). For example, the location of the members 104A-N may be determined based on the member data stored in the member repository 106.

In operation 610, a determination is made whether to offer decorations to the member 104. If the decorations are not to be offered to the member 104, the process of making a purchase may terminate. In operation 612, a selection of the occasion is obtained from the member 104 (e.g., using the commerce module 112 of FIG. 1). For example, selection of the occasion obtained from the member 104 may include a national holiday, a secular holiday, a cultural holiday, a religious holiday, an event, and/or a celebration, etc.

In operation 614, decoration options associated with the occasion are displayed (e.g., as illustrated in Halloween decorations option 302 of FIG. 3) to the member 104. In one example embodiment, the decoration options may include type of decorations (e.g., pumpkins, scarecrows, broomsticks, etc. for Halloween celebrations) associated with a particular occasion (e.g., selected by the member 104). In operation 616, a purchase selection of the decoration options is obtained (e.g., using the commerce module 112 Of FIG. 1) from the member 104.

The purchase selection may include specifying number of decorations to be displayed. In operation 618, the residence representation (e.g., may include an image of a residence) and decoration representations (e.g., may include image of pumpkins, broomsticks, and/or scarecrows, etc.) are displayed on the geo-spatial map 200. In operation 620, the decorations are delivered (e.g., using the commerce module 112 of FIG. 1) to the member 104.

The decorations (e.g., purchased by the member 104) may be delivered through a postal service, courier service, and/or delivery service, etc. In operation 622, a condition is checked whether the purchase associated with the member is completed or not. In one example embodiment, if the purchase is completed, the process may be terminated, else the process of obtaining a selection of an occasion from the member (e.g., as illustrated in operation 612) may be performed.

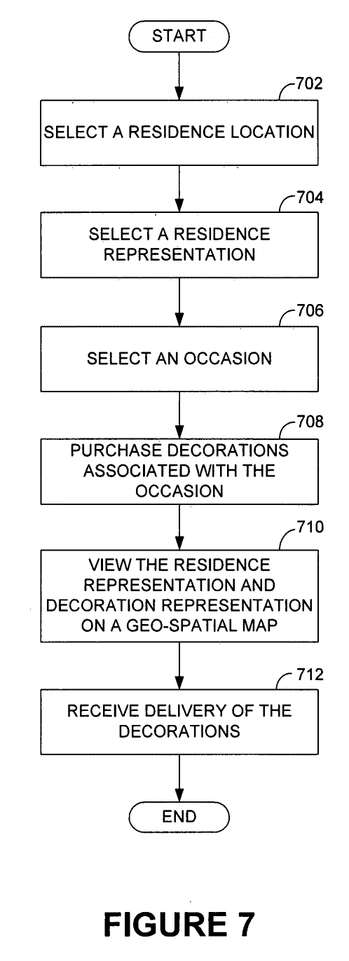

FIG. 7 is a flowchart of receiving delivery of decorations associated with an occasion, according to one embodiment. In operation 702, a location is selected (e.g., using the commerce module 112 of FIG. 1). For example, the location may be a geographical area (e.g., associated with the member 104) displayed on the geo-spatial map 200. In operation 704, a residence representation (e.g., the residence representation 208 of FIG. 2) is selected (e.g., using the commerce module 112 of FIG. 1). For example, the residence representation 208 may be an image of a residence, business, and/or civic structure, etc.

In operation 706, the occasion is selected (e.g., using the commerce module 112 of FIG. 1). For example, the occasion may include Halloween, Thanksgiving, Christmas, Hanukkah, New Year, birthday, etc. In operation 708, the decorations associated with the occasion are purchased (e.g., using the commerce module 112 of FIG. 1). For example, decorations associated with Christmas may include Christmas tree, garlands, Christmas star, etc. and decorations associated with Halloween may include pumpkin carvings, turnip carvings, ghosts, etc.

In operation 710, the residence representation and decoration representations are viewed on the geo-spatial map 200. For example, decoration representations (e.g., of the purchased decorations) may be displayed in conjunction with the residence representation 208 on the geo-spatial map 200 (e.g., as illustrated in FIG. 4). In operation 712, delivery of decorations is received (e.g., using the commerce module 112 of FIG. 1). For example, the delivery may be received through a postal service, delivery service, and/or courier service, etc.

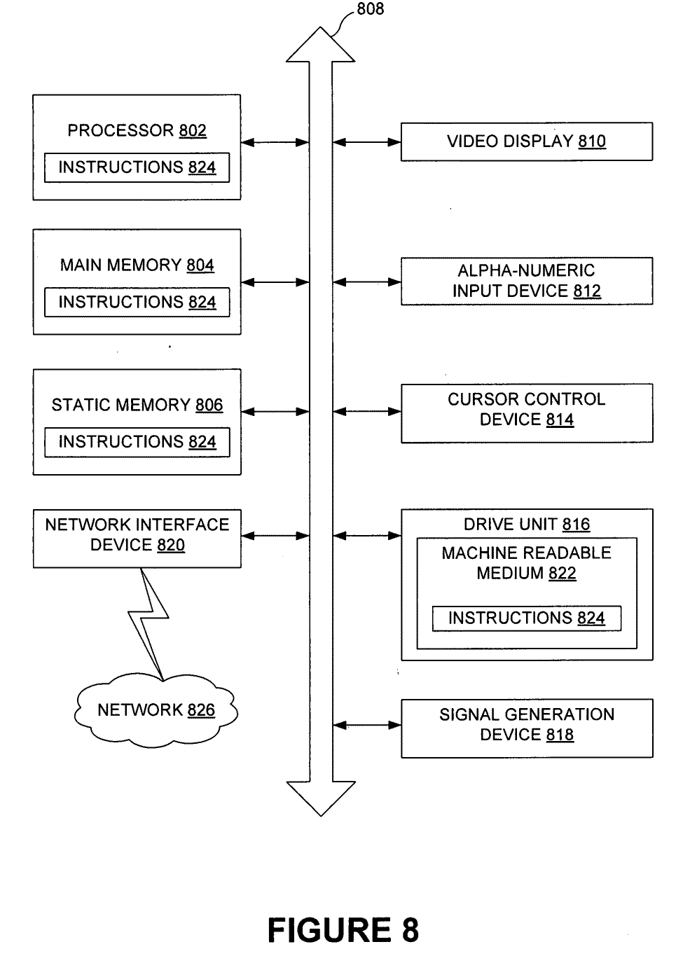

FIG. 8 is a diagrammatic system view 800 of a data processing system in which any of the embodiments disclosed herein may be performed, according to one embodiment. Particularly, the diagrammatic system view 800 of FIG. 8 illustrates a processor 802, a main memory 804, a static memory 806, a bus 808, a video display 810, an alpha-numeric input device 812, a cursor control device 814, a drive unit 816, a signal generation device 818, a network interface device 820, a machine readable medium 822, instructions 824 and a network 826, according to one embodiment.

The diagrammatic system view 800 may indicate a personal computer and/or a data processing system in which one or more operations disclosed herein are performed. The processor 802 may be microprocessor, a state machine, an application specific integrated circuit, a field programmable gate array, etc. (e.g., Intel® Pentium® processor). The main memory 804 may be a dynamic random access memory and/or a primary memory of a computer system.

The static memory 806 may be a hard drive, a flash drive, and/or other memory information associated with the data processing system. The bus 808 may be an interconnection between various circuits and/or structures of the data processing system. The video display 810 may provide graphical representation of information on the data processing system. The alpha-numeric input device 812 may be a keypad, keyboard and/or any other input device of text (e.g., special device to aid the physically handicapped). The cursor control device 814 may be a pointing device such as a mouse.

The drive unit 816 may be the hard drive, a storage system, and/or other longer term storage subsystem. The signal generation device 818 may be a bios and/or a functional operating system of the data processing system. The network interface device 820 may be a device that may perform interface functions such as code conversion, protocol conversion and/or buffering required for communication to and from a network.

The machine readable medium 822 may provide instructions on which any of the methods disclosed herein may be performed. The instructions 824 may provide source code and/or data code to the processor 802 to enable any one or more operations disclosed herein.

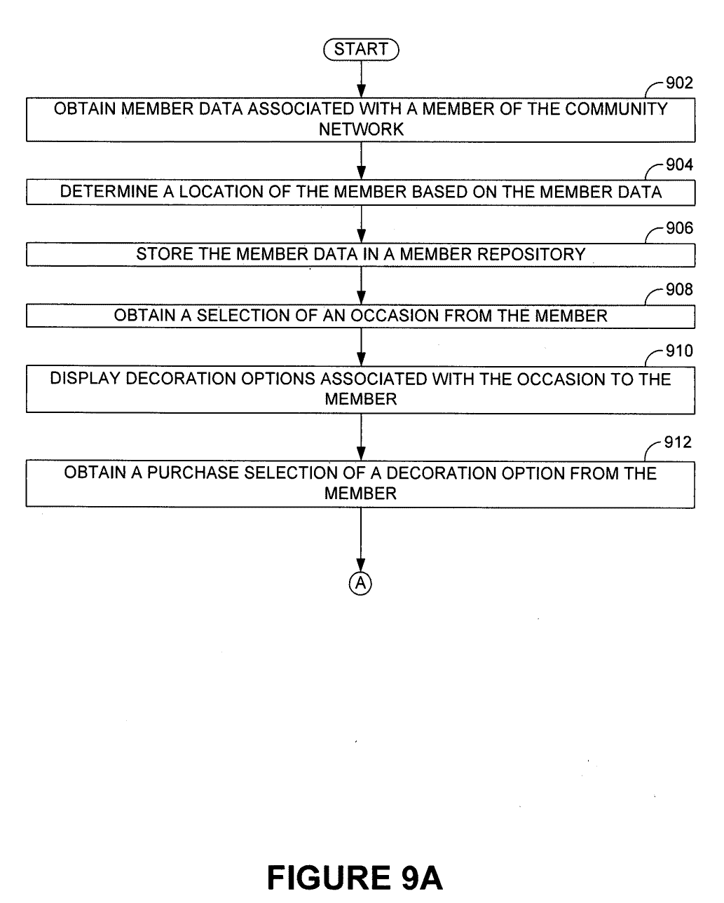

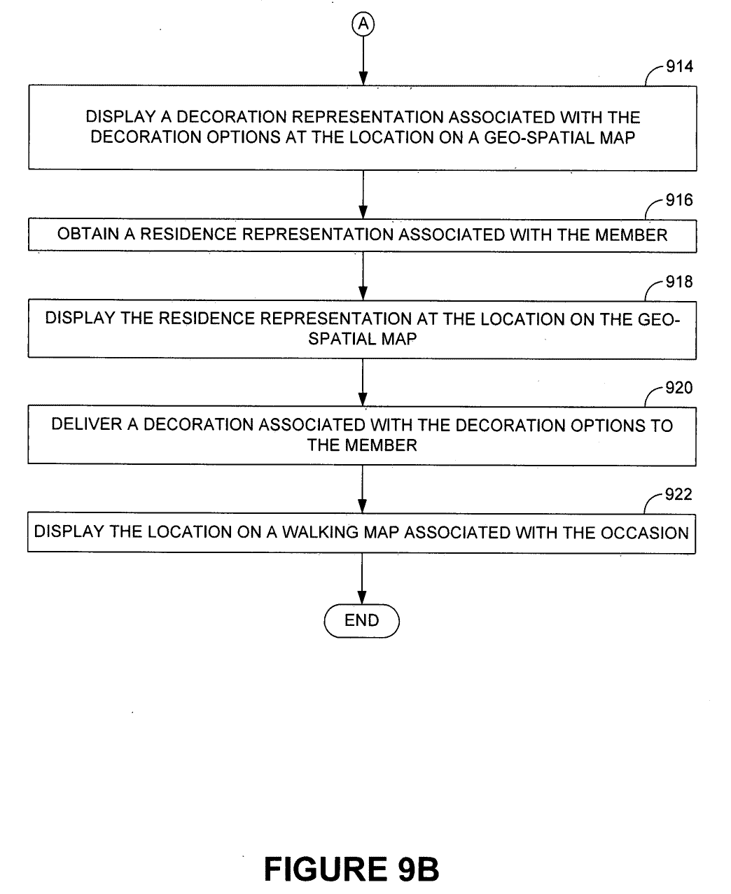

FIG. 9A is a process flow of displaying decoration representations on a geo-spatial map 200 (e.g., the geo-spatial map 200 of FIG. 2), according to one embodiment. In operation 902, member data associated with a member (e.g., the members 104A-N of FIG. 1) of a community network (e.g., the community network 100 of FIG. 1) may be obtained (e.g., through the member management module 110 of FIG. 1). In operation 904, a location (e.g., may include a latitude, a longitude, and/or an altitude, etc.) of the member 104 may be determined (e.g., based on the member data). In operation 906, the member data may be stored in a member repository 106.

In operation 908, a selection of an occasion may be obtained (e.g., through the commerce module 112 of FIG. 1) from the member 104. In operation 910, decoration options associated with the occasion may be displayed (e.g., using the commerce module 112 of FIG. 1) to the member 104. In operation 912, a purchase selection of a decoration option may be obtained (e.g., using the commerce module 112 of FIG. 1) from the member 104.

FIG. 9B is a continuation of the process flow of FIG. 9A, showing additional processes, according to one embodiment. In operation 914, the decoration representation (e.g., the decoration representations 1 402, 2 404, 3 406 and 4 408 of FIG. 4) associated with the decoration options may be displayed (e.g., using the commerce module 112 of FIG. 1) at the location (e.g., selected by the member 104) on the geo-spatial map 200. In operation 916, a residence representation (e.g., the residence representation 208 of FIG. 2) associated with the member 104 may be obtained (e.g., using the commerce module 112 of FIG. 1).

In operation 918, the residence representation 208 may be displayed (e.g., using the commerce module 112 of FIG. 1) at the location (e.g., associated with the member 104) on the geo-spatial map 200. In operation 920, a decoration associated with the decoration options may be delivered (e.g., through postal service, courier service, and/or delivery service, etc.) to the member 104. In operation 922, the location (e.g., associated with the occasion) may be displayed (e.g., using the commerce module 112 of FIG. 1) on a walking map associated with the occasion. For example, a walking map may be a geo-spatial map with routes that allow members 104A-N to explore neighborhoods and/or larger areas by navigating. The walking map may also display the decoration representations 1 402, 2 404, 3 406 and 4 408 simultaneously with the residence representation 208 associated with the occasion (e.g., Halloween, Christmas, Thanksgiving, and/or New Year, etc.).

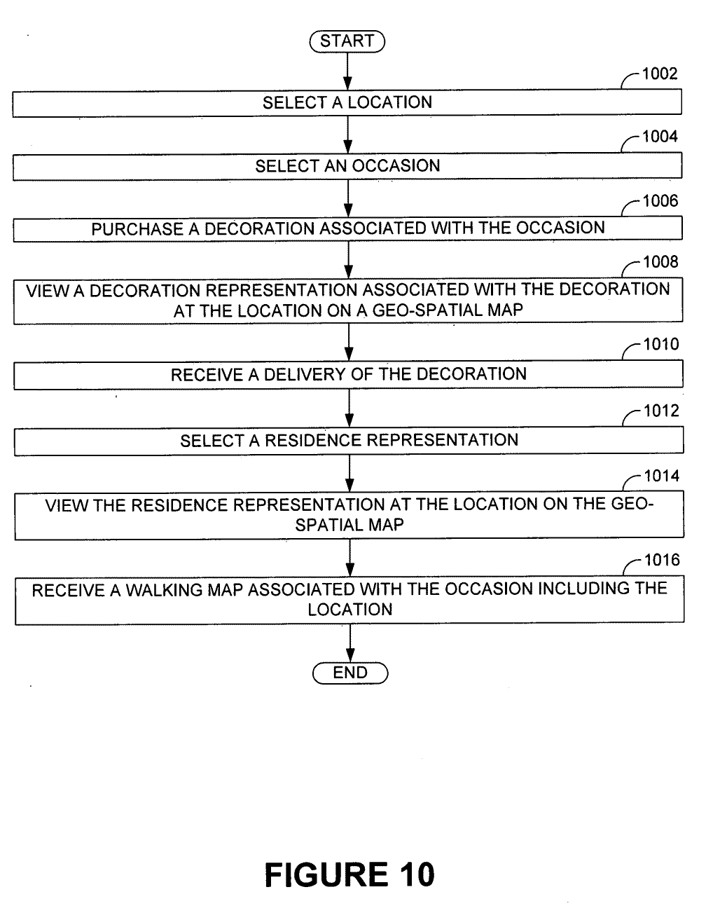

FIG. 10 is a process flow of making a purchase of decorations associated with an occasion, according to one embodiment. In operation 1002, a location may be selected (e.g., using the geo-spatial repository 108 of FIG. 1). In operation 1004, the occasion (e.g., Halloween, Thanksgiving, Christmas, Hanukkah, New Year, and/or birthday, etc.) may be selected (e.g., using the commerce module 112 of FIG. 1).

In operation 1006, a decoration associated with the occasion may be purchased (e.g., using the commerce module 112 of FIG. 1). For example, the decoration for Halloween may include pumpkins, ghosts, scarecrows, etc. In operation 1008, a decoration representation (e.g., the decoration representations 1 402, 2 404, 3 406 and 4 408 of FIG. 4) associated with the decoration may be viewed at the location on a geo-spatial map (e.g., the geo-spatial map 200 of FIG. 2). In operation 1010, a delivery of the decoration may be received (e.g., through postal service, delivery service, courier service, etc.).

In operation 1012, a residence representation (e.g., an image of a residence, business, and/or civic structure, etc.) may be selected. In operation 1014, the residence representation 208 may be viewed (e.g., using the commerce module 112 of FIG. 1) at the location on the geo-spatial map 200 (e.g., along with decoration representations). In operation 1016, a walking map associated with the occasion including the location may be received. For example, the walking map received by the member may also display the decoration representations 1 402, 2 404, 3 406 and 4 408 simultaneously with the residence representation 208 associated with the occasion.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the various electrical structure and methods may be embodied using transistors, logic gates, and electrical circuits (e.g., Application Specific Integrated Circuitry (ASIC) and/or in Digital Signal Processor (DSP) circuitry). For example, the member management module 110, the commerce module 112, and other modules of FIGS. 1-10 may be may be enabled using a member management circuit, a commerce circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of organizing a community network, comprising:
obtaining member data associated with a member of the community network;
determining a location of the member based on the member data;
storing the member data in a member repository;
obtaining a selection of an occasion from the member;
displaying a plurality of decoration options associated with the occasion to the member;
obtaining a purchase selection of one of the plurality of decoration options from the member; and
displaying a decoration representation associated with the one of the plurality of decoration options at the location on a geo-spatial map.

2. The method of claim 1, further comprising:
obtaining a residence representation associated with the member; and
displaying the residence representation at the location on the geo-spatial map.

3. The method of claim 2, wherein the residence representation comprises an image of a residence.

4. The method of claim 2, wherein the residence representation is based on a residence type.

5. The method of claim 1, further comprising:
delivering a decoration associated with the one of the plurality of decoration options to the member.

6. The method of claim 1, further comprising:
displaying the location on a walking map associated with the occasion.

7. The method of claim 1 in a form of a machine-readable medium embodying a set of instructions that, when executed by a machine, causes the machine to perform the method of claim 1.

8. A community network, comprising:
a member repository comprising a plurality of members;
a geo-spatial repository comprising a plurality of locations on a geo-spatial map;
a member management module configured to obtain member data associated with each of the plurality of members, wherein the member data comprises one of the plurality of locations; and
a commerce module configured to:
obtain a selection of an occasion from one of the plurality of members;
display a plurality of decoration options associated with the occasion to the one of the plurality of members;
obtain a purchase selection of one of the plurality of decoration options from the one of the plurality of members; and
display a decoration representation associated with the one of the plurality of decoration options at the one of the plurality of locations associated with the one of the plurality of members on the geo-spatial map.

9. The community network of claim 8, wherein the commerce module is further configured to:
obtain a residence representation associated with the one of the plurality of members; and
display the residence representation at the one of the plurality of locations on the geo-spatial map.

10. The community network of claim 9, wherein the residence representation comprises an image of a residence.

11. The community network of claim 9, wherein the residence representation is based on a residence type.

12. The community network of claim 8, wherein the commerce module is further configured to:
deliver a decoration associated with the one of the plurality of decoration options to the one of the plurality of members.

13. The community network of claim 8, wherein the commerce module is further configured to:
display the one of the plurality of locations on a walking map associated with the occasion.

14. The community network of claim 8, wherein the occasion is at least one of a national holiday, a cultural holiday, a religious holiday, a secular holiday, an event, and a celebration.

15. A method of making a purchase, comprising:
selecting a location;
selecting an occasion;
purchasing a decoration associated with the occasion;
viewing a decoration representation associated with the decoration at the location on a geo-spatial map; and
receiving a delivery of the decoration.

16. The method of claim 15, further comprising:
selecting a residence representation; and
viewing the residence representation at the location on the geo-spatial map.

17. The method of claim 16, wherein the residence representation comprises an image of a residence.

18. The method of claim 15, further comprising:
receiving a walking map associated with the occasion comprising the location.

19. The method of claim 15, wherein the decoration is delivered using at least one of a postal service and a delivery service.

20. The method of claim 15, wherein the occasion is at least one of a national holiday, a cultural holiday, a religious holiday, a secular holiday, an event, and a celebration.
